(19) United States
(12) Patent Application Publication
(10) Pub. No.: US 2026/0024374 A1
(43) Pub. Date: Jan. 22, 2026

(54) APPARATUS FOR ULTRASONIC DETECTION AND ELECTRONIC DEVICE

(71) Applicant: HUIKE (SINGAPORE) HOLDING PTE. LTD., Singapore (SG)

(72) Inventor: Canhong DU, Shenzhen (CN)

(73) Assignee: HUIKE (SINGAPORE) HOLDING PTE. LTD., Singapore (SG)

(21) Appl. No.: 19/341,908

(22) Filed: Sep. 26, 2025

Related U.S. Application Data
(63) Continuation of application No. PCT/IB2025/051347, filed on Feb. 8, 2025.

(30) Foreign Application Priority Data
Feb. 8, 2024 (CN) 202410177052.X

(51) Int. Cl. G06V 40/13; G06V 40/12

(52) U.S. Cl. CPC G06V 40/1306; G06V 40/1347

(57) ABSTRACT

An apparatus for ultrasonic detection and an electronic device are provided. The apparatus for ultrasonic detection is arranged below a cover plate of an electronic device to perform touch detection on the cover plate, and comprises: a piezoelectric transducer and a circuit unit; wherein the piezoelectric transducer is configured to emit a first ultrasonic signal to the cover plate, receive a first reflected ultrasonic signal formed by reflection of the first ultrasonic signal, convert the first reflected ultrasonic signal into a first electrical signal, and then input the first electrical signal into the circuit unit; and the circuit unit is configured to generate a touch detection signal for indicating a touch state of the cover plate based on the first electrical signal.

### CROSS REFERENCE

The present disclosure is a continuation application of PCT/IB2025/051347 filed on Feb. 8, 2025 titled “APPARATUS FOR ULTRASONIC DETECTION AND ELECTRONIC DEVICE”, which claims priority to Chinese invention application No. 202410177052.X filed on Feb. 8, 2024 titled “APPARATUS FOR ULTRASONIC DETECTION AND ELECTRONIC DEVICE”, the entire contents of which are incorporated herein by references.

### TECHNICAL FIELD

The present disclosure relates to the technical field of touch detection, and particularly relates to an apparatus for ultrasonic detection and an electronic device.

### BACKGROUND

At present, an apparatus for capacitive touch detection is generally used in related art to detect a finger touch, e.g., by detecting a capacitance between a detection electrode and a touch pad in the apparatus for capacitive touch detection, to determine whether there is a finger touch on the touch pad. However, detection effects of the apparatus for capacitive touch detection are greatly affected by an environment. For example, dust in the environment falling on the touch pad will change the capacitance between the detection electrode and the touch pad, and temperature and humidity changes of the environment will also change the capacitance between the detection electrode and the touch pad, thereby resulting in poor stability of the apparatus for capacitive touch detection in touch detection.

### SUMMARY

In view of this, embodiments of the present disclosure provide an apparatus for ultrasonic detection and an electronic device, to at least partially solve the above problems.

According to an embodiment in a first aspect of the present disclosure, an apparatus for ultrasonic detection is provided, wherein the apparatus for ultrasonic detection is arranged below a cover plate of an electronic device to perform touch detection on the cover plate, and comprises: a piezoelectric transducer and a circuit unit; wherein the piezoelectric transducer is configured to emit a first ultrasonic signal to the cover plate, receive a first reflected ultrasonic signal formed by reflection of the first ultrasonic signal, convert the first reflected ultrasonic signal into a first electrical signal, and then input the first electrical signal into the circuit unit; and the circuit unit is configured to generate a touch detection signal for indicating a touch state of the cover plate based on the first electrical signal.

In a possible implementation, the piezoelectric transducer is configured to emit a second ultrasonic signal to the cover plate, receive a second reflected ultrasonic signal formed by reflection of the second ultrasonic signal, convert the second reflected ultrasonic signal into a second electrical signal, and then input the second electrical signal into the circuit unit; and the circuit unit is configured to generate a fingerprint recognition signal for indicating a fingerprint feature based on the second electrical signal.

In a possible implementation, the piezoelectric transducer comprises an electrode array, a piezoelectric layer, and a common electrode, wherein the common electrode and the electrode array are located on opposite sides of the piezoelectric layer respectively; the common electrode is configured to drive the piezoelectric layer to emit the first ultrasonic signal or the second ultrasonic signal; and the piezoelectric layer is configured to convert the first reflected ultrasonic signal into the first electrical signal acting on the electrode array after receiving the first reflected ultrasonic signal, and convert the second reflected ultrasonic signal into the second electrical signal acting on the electrode array after receiving the second reflected ultrasonic signal; wherein, when the piezoelectric layer emits the first ultrasonic signal or the second ultrasonic signal, the electrode array is grounded, and when the piezoelectric layer receives the first reflected ultrasonic signal or the second reflected ultrasonic signal, the common electrode is grounded.

In a possible implementation, the electrode array comprises a plurality of electrodes; the circuit unit comprises a plurality of preprocessing circuits and an output unit; each of the plurality of preprocessing circuits is connected to the output unit; and different preprocessing circuits are connected to different electrodes; each of the preprocessing circuits is configured to preprocess the first electrical signal to generate a first preprocessed signal, or preprocess the second electrical signal to generate a second preprocessed signal; the output unit is configured to generate the touch detection signal based on the first preprocessed signal and output the touch detection signal, or generate the fingerprint recognition signal based on the second preprocessed signal and output the fingerprint recognition signal; when the piezoelectric layer receives the first reflected ultrasonic signal, some of the preprocessing circuits connected to some of the electrodes included in the electrode array are in a working state, other preprocessing circuits connected to other electrodes included in the electrode array are in a sleep state; and when the piezoelectric layer receives the second reflected ultrasonic signal, all of the preprocessing circuits connected to all of the electrodes included in the electrode array are in a working state.

In a possible implementation, the circuit unit contacts the electrode array; and the common electrode is configured to contact the cover plate through an adhesive layer, or the circuit unit contacts the cover plate through an adhesive layer.

In a possible implementation, the piezoelectric layer is configured to receive, in response to starting to emit the first ultrasonic signal to the cover plate via the piezoelectric layer at a first moment, the first reflected ultrasonic signal after a first time from the first moment, a value range of the first time being (1.8 T, 3 T); and T is a time interval from starting to emit the ultrasonic signal via the piezoelectric layer to starting to receive a target reflected signal via the piezoelectric layer, wherein the target reflected signal is a signal formed by reflection of the ultrasonic signal from a touch surface of the cover plate.

In a possible implementation, the piezoelectric layer is configured to receive, in response to starting to emit the second ultrasonic signal to the cover plate via the piezoelectric layer at a second moment, the second reflected ultrasonic signal after a second time from the second moment; wherein a value range of the second time is different from the value range of the first time.

In a possible implementation, the value range of the second time is (1.5 T, 2 T).

According to an embodiment in a second aspect of the present disclosure, an electronic device is provided, comprising: a cover plate and the apparatus for ultrasonic detection according to any one of the above embodiments; wherein the cover plate is configured to provide a touch surface configured to receive a finger touch; and the apparatus for ultrasonic detection is arranged below the cover plate to perform touch detection on the cover plate.

In a possible implementation, the cover plate is formed from a conductive material or a non-conductive material.

In an embodiment of the present disclosure, the apparatus for ultrasonic detection comprises a piezoelectric transducer and a circuit unit. The piezoelectric transducer can emit a first ultrasonic signal to the cover plate, receive a first reflected ultrasonic signal formed by reflection of the first ultrasonic signal, convert the first reflected ultrasonic signal into a first electrical signal, and then input the first electrical signal into the circuit unit. The circuit unit can generate a touch detection signal for indicating a touch state of the cover plate based on the first electrical signal, so as to determine whether there is a finger on the cover plate based on the touch detection signal. Hence, in the embodiments of the present disclosure, the touch detection signal can be generated based on the first reflected ultrasonic signal formed by reflection of the first ultrasonic signal. Since acoustic impedance of dust is very small, and the ultrasonic signal is less affected by temperature and humidity, the touch detection signal is generated based on the first reflected ultrasonic signal in the present disclosure, thereby reducing the influence of environmental factors such as dust, temperature and humidity on the touch detection signal, and improving the detection accuracy of finger touch on the cover plate.

### BRIEF DESCRIPTION OF DRAWINGS

To more clearly describe technical solutions of embodiments of the present disclosure or the prior art, drawings to be used in the description of the embodiments or the prior art will be briefly introduced below. Apparently, the drawings in the description below are merely some embodiments disclosed in the embodiments of the present disclosure. For those of ordinary skills in the art, other drawings may also be obtained based on these drawings.

FIG. 1 is a schematic structural diagram of an apparatus for ultrasonic detection provided in an optional embodiment of the present disclosure.

FIG. 2 is a schematic temporal diagram of signals provided in an optional embodiment of the present disclosure.

FIG. 3 is an arrangement diagram of an electrode array provided in an optional embodiment of the present disclosure.

FIG. 4 is an arrangement diagram of some electrodes in an electrode array provided in an optional embodiment of the present disclosure.

FIG. 5 is an arrangement diagram of some electrodes in another electrode array provided in an optional embodiment of the present disclosure.

FIG. 6 is an arrangement diagram of some electrodes in still another electrode array provided in an optional embodiment of the present disclosure.

FIG. 7 is a schematic structural diagram of another apparatus for ultrasonic detection provided in an optional embodiment of the present disclosure.

FIG. 8 is a schematic diagram of overall workflow of an apparatus for ultrasonic detection provided in an optional embodiment of the present disclosure.

FIG. 9 is a schematic diagram of workflow of an apparatus for ultrasonic detection in a touch detection mode provided in an optional embodiment of the present disclosure.

### REFERENCE NUMERALS

100: Apparatus for ultrasonic detection; 110: Piezoelectric transducer; 111: Electrode array; 1111: Electrode; 112: Piezoelectric layer; 113: Common electrode; 120: Circuit unit; 121: Silicon substrate;
200: Cover plate; 300: Adhesive layer.

### DETAILED DESCRIPTION

To enable those skilled in the art to better understand technical solutions of embodiments of the present disclosure, the technical solutions of the embodiments of the present disclosure will be clearly and completely described below with reference to the drawings in the embodiments of the present disclosure. Apparently, the described embodiments are merely some, instead of all, of the embodiments of the present disclosure. All other embodiments obtained by those of ordinary skills in the art based on some embodiments among the embodiments of the present disclosure should be encompassed within the scope of protection of the embodiments of the present disclosure.

The terms used in the present disclosure are intended merely to describe particular embodiments, and are not intended to limit the present disclosure. The singular forms of “a” and “the” used in the present disclosure and the appended claims are also intended to include plural forms, unless the context explicitly indicates other meanings. It should be further understood that the term “and/or” used herein refers to and includes any or all possible combinations of one or more associated enumerated items.

It should be understood that various kinds of information may be described by using the terms, such as first, second, and third, in the present disclosure, but the information should not be limited to these terms. These terms are merely used to distinguish between information of a same type. For example, the first piece of information may also be referred to as the second piece of information, and similarly, the second piece of information may also be referred to as the first piece of information, without departing from the scope of the present disclosure. Depending on the context, as used herein, the word “if” may be interpreted as “at the time of . . . ” or “when . . . ” or “in response to determining.”

The present disclosure provides an apparatus for ultrasonic detection and an electronic device, to solve the above problems existing in the related art.

The apparatus for ultrasonic detection provided in the embodiments of the present disclosure is described in detail below in conjunction with the drawings.

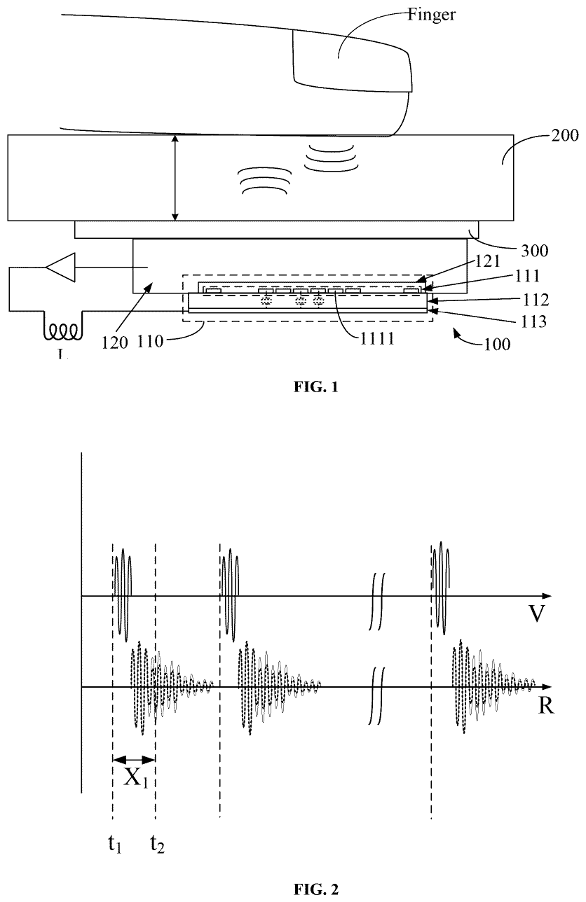

As shown in FIG. 1, an apparatus 100 for ultrasonic detection is arranged below a cover plate 200 of an electronic device to perform touch detection on the cover plate 200. The apparatus for ultrasonic detection 100 comprises: a piezoelectric transducer 110 and a circuit unit 120.

In an embodiment of the present disclosure, the electronic device may be an electronic device such as a mobile phone or a tablet, and the cover plate 200 of the electronic device may be a cover plate 200 of a fingerprint recognition area on a side surface of an electronic device such as a mobile phone or a tablet.

The piezoelectric transducer 110 is configured to emit a first ultrasonic signal to the cover plate 200, receive a first reflected ultrasonic signal formed by reflection of the first ultrasonic signal, convert the first reflected ultrasonic signal into a first electrical signal, and then input the first electrical signal into the circuit unit 120.

The piezoelectric transducer 110 may comprise a piezoelectric material, such as polyvinylidene difluoride (PVDF), thereby converting a voltage signal acting on the piezoelectric material into a corresponding ultrasonic signal or converting an ultrasonic signal acting on the piezoelectric material into a corresponding voltage signal using piezoelectric effects of the piezoelectric material.

The circuit unit 120 is configured to generate a touch detection signal for indicating a touch state of the cover plate 200 based on the first electrical signal. The circuit unit 120 may be an integrated circuit in the form of a chip, so as to reduce the space occupied by the circuit unit 120. It should be understood that the touch state of the cover plate 200 comprises two states: there is a finger touch on the touch surface of the cover plate 200, and there is no finger touch on the touch surface of the cover plate 200.

When there is no finger touch, air is on the touch surface of the cover plate 200. Acoustic impedance of a material (such as an aluminum alloy or plastic) commonly used for the cover plate 200 is generally greater than 1.5 Mrayl, acoustic impedance of air is about 0.00043 Mrayl, and acoustic impedance of a finger is about Z2=1.5 Mrayl. If the acoustic impedance of the cover plate 200 is denoted as Z1, and acoustic impedance of an object in contact with the touch surface of the cover plate 200 is denoted as Z2, reflectivity rf of the first ultrasonic signal emitted from the piezoelectric transducer 110 to the cover plate 200 on the touch surface of the cover plate 200 can be calculated as per the following formula.

$$rf = \frac{Z 1 - Z 2}{Z 1 + Z 2}$$

When there is no finger touch on the cover plate 200, Z2=0.00043 Mrayl. In this case, the rf is about 1, and the first ultrasonic signal is almost completely reflected back to the piezoelectric transducer 110 from the touch surface of the cover plate 200. When there is a finger touch on the cover plate 200, Z2=1.5 Mrayl. In this case, the rf is obviously less than 1, and the first ultrasonic signal can only be partially reflected back to the piezoelectric transducer 110 from the touch surface of the cover plate 200, that is, when the first ultrasonic signal is reflected from the touch surface of the cover plate 200, there will be obvious reflection losses.

As an example, as shown in FIG. 2, solid line on the V axis is a waveform of the first ultrasonic signal changing with time. Solid line on the R axis is a waveform of the first reflected ultrasonic signal changing with time when there is no touch on the touch surface of the cover plate 200, and dotted line on the R axis is a waveform of the first reflected ultrasonic signal changing with time when there is a touch on the touch surface of the cover plate 200. As can be seen from FIG. 2, there is an obvious difference between a fluctuation amplitude of the first reflected ultrasonic signal obtained when there is a touch on the cover plate 200 and a fluctuation amplitude of the first reflected ultrasonic signal obtained when there is no touch on the cover plate 200. Since the piezoelectric transducer 110 converts the first reflected ultrasonic signal into the first electrical signal, there will also be a corresponding difference between the first electrical signal converted from the first reflected ultrasonic signal when there is a touch on the cover plate 200 and the first electrical signal converted from the first reflected ultrasonic signal when there is no touch on the cover plate 200. Therefore, the touch detection signal indicating the touch state of the cover plate 200 can be generated based on the first electrical signal.

In some optional embodiments, the circuit unit 120 may use the received first electrical signal as the touch detection signal, or may amplify, differentiate, or denoise the first electrical signal and then use the processed signal as the touch detection signal, both of which are encompassed within the scope of protection of the embodiments of the present disclosure.

As shown in FIG. 2, in some optional embodiments, the piezoelectric transducer 110 can continuously emit a plurality of first ultrasonic signals, and receive a first reflected ultrasonic signal emitted each time to generate corresponding first electrical signals, so that the circuit unit 120 generates touch detection signals corresponding to the plurality of emitted first ultrasonic signals. By superimposing these touch detection signals, the first reflected ultrasonic signals obtained from the plurality of emitted first ultrasonic signals can be integrated to perform touch detection, so as to more accurately determine the touch state of the cover plate 200.

In an embodiment of the present disclosure, the apparatus 100 for ultrasonic detection comprises a piezoelectric transducer 110 and a circuit unit 120. The piezoelectric transducer 110 can emit a first ultrasonic signal to the cover plate 200, receive a first reflected ultrasonic signal formed by reflection of the first ultrasonic signal, convert the first reflected ultrasonic signal into a first electrical signal, and then input the first electrical signal into the circuit unit 120. The circuit unit 120 can generate a touch detection signal for indicating a touch state of the cover plate 200 based on the first electrical signal, so as to determine whether there is a finger on the cover plate 200 based on the touch detection signal. That is, in an embodiment of the present disclosure, the touch detection signal can be generated based on the first reflected ultrasonic signal formed by reflection of the first ultrasonic signal. Since acoustic impedance of dust is very small, and the ultrasonic signal is less affected by temperature and humidity, the touch detection signal is generated based on the first reflected ultrasonic signal in the present disclosure, thereby reducing the influence of environmental factors such as dust, temperature and humidity on the touch detection signal, and significantly improving the stability of the touch detection.

In some optional embodiments, the piezoelectric transducer 110 is configured to emit a second ultrasonic signal to the cover plate 200, receive a second reflected ultrasonic signal formed by reflection of the second ultrasonic signal, convert the second reflected ultrasonic signal into a second electrical signal, and then input the second electrical signal into the circuit unit 120; and the circuit unit 120 is configured to generate a fingerprint recognition signal for indicating a fingerprint feature based on the second electrical signal.

Since a fingerprint has uneven textures, when a finger is pressed on a touch surface of the cover plate 200, convex parts of the fingerprint can contact the touch surface, and clearances will be formed between concave parts of the fingerprint and the touch surface. When the second ultrasonic signal acts on the touch surface, the second reflected ultrasonic signal obtained from reflection of the second ultrasonic signal at fingerprint contact points and the fingerprint clearances on the touch surface has different intensities, so that different corresponding second electrical signals are generated. Based on this, the fingerprint recognition signal indicating the fingerprint feature can be generated according to the second electrical signal. Then, by corresponding processing on the fingerprint recognition signal, a corresponding fingerprint image can be obtained. The related art may be referred to a specific implementation of the above process, which will not be repeated here.

In an embodiment of the present disclosure, a plurality of second ultrasonic signals can be emitted, fingerprint recognition signals corresponding to the plurality of emitted second ultrasonic signals can be generated, and a plurality of fingerprint images can be obtained based on fingerprint recognition signals corresponding to the plurality of emitted second ultrasonic signals. By superimposing the plurality of fingerprint images, a clearer fingerprint image can be obtained to improve the accuracy of fingerprint recognition.

In an existing solution for under-screen ultrasonic fingerprint recognition, it is usually necessary to first perform touch detection using a related apparatus for capacitive touch detection, and then perform ultrasonic fingerprint recognition after detecting that there is a finger touch on a screen. Although the existing solution for under-screen ultrasonic fingerprint recognition can perform both touch detection and fingerprint recognition, the solution still has some defects. For example, circuit structure corresponding to the solution is complex and occupies a large space, and limited to capacitive detection, the solution can hardly be applied to a case where the touch surface is a metal. The apparatus 100 for ultrasonic detection provided in an embodiment of the present disclosure can at least partially overcome the above defects of the existing solution for under-screen ultrasonic fingerprint recognition.

In an embodiment of the present disclosure, the piezoelectric transducer 110 can emit a second ultrasonic signal to the cover plate 200, receive a second reflected ultrasonic signal formed by reflection of the second ultrasonic signal, convert the second reflected ultrasonic signal into a second electrical signal, and then input the second electrical signal into the circuit unit 120. The circuit unit 120 generates a fingerprint recognition signal for indicating a fingerprint feature based on the second electrical signal, thereby performing fingerprint recognition based on the fingerprint recognition signal. Both touch detection and fingerprint recognition can be performed via the piezoelectric transducer 110, which can improve the utilization rate of the piezoelectric transducer 110, and can reduce the complexity of the related circuit structure and reduce the space occupied by it without the need to arrange a sensor for touch detection and a sensor for fingerprint recognition respectively. Moreover, since acoustic impedance of a metal material such as an aluminum alloy or a stainless steel is much greater than acoustic impedance of air, the touch surface of the cover plate 200 in the embodiments of the present disclosure can be made of a metal material such as an aluminum alloy or a stainless steel, that is, the apparatus 100 for ultrasonic detection in the embodiments of the present disclosure has high adaptability.

As shown in FIG. 1, in some optional embodiments, the piezoelectric transducer 110 comprises an electrode array 111, a piezoelectric layer 112, and a common electrode 113, wherein the common electrode 113 and the electrode array 111 are located on opposite sides of the piezoelectric layer 112 respectively.

The common electrode 113 is configured to drive the piezoelectric layer 112 to emit a first ultrasonic signal or a second ultrasonic signal. In an embodiment of the present disclosure, a high-voltage pulse can be received by the common electrode 113, and the high-voltage pulse can be applied to the piezoelectric layer 112, thereby driving the piezoelectric layer 112 to emit the first ultrasonic signal or the second ultrasonic signal. It should be understood that same high-voltage pulses can drive the piezoelectric layer 112 to emit same first ultrasonic signal and same second ultrasonic signal, and different high-voltage pulses can drive the piezoelectric layer 112 to emit different first ultrasonic signals and different second ultrasonic signals.

The piezoelectric layer 112 is configured to convert the first reflected ultrasonic signal into the first electrical signal acting on the electrode array 111 after receiving the first reflected ultrasonic signal, and convert the second reflected ultrasonic signal into the second electrical signal acting on the electrode array 111 after receiving the second reflected ultrasonic signal.

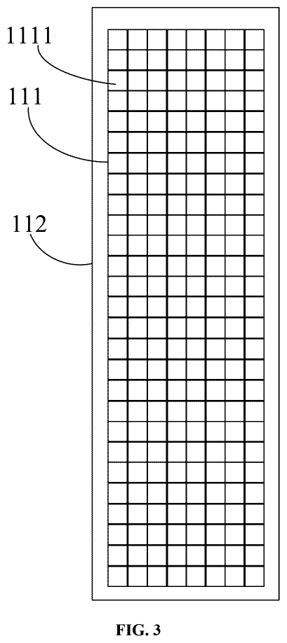

As shown in FIGS. 1 and 3, the electrode array 111 may be an array formed by arranging a plurality of electrodes 1111, and may be generally arranged on a silicon substrate 121 of a chip.

When the piezoelectric layer 112 emits the first ultrasonic signal or the second ultrasonic signal, the electrode array 111 is grounded, and when the piezoelectric layer 112 receives the first reflected ultrasonic signal or the second reflected ultrasonic signal, the common electrode 113 is grounded.

In an embodiment of the present disclosure, the electrode array 111 is grounded when the piezoelectric layer 112 emits the first ultrasonic signal or the second ultrasonic signal, which is conductive to forming a high voltage between the common electrode 113 and the electrode array 111, increasing the intensity of the emitted ultrasonic wave, and enhancing the sensitivity of the piezoelectric transducer 110. Moreover, a consistent voltage can be formed among the common electrode 113 and all electrodes of the electrode array 111, so that the piezoelectric layer 112 among the common electrode 113 and each electrode of the electrode array 111 can generate a consistent first ultrasonic signal or second ultrasonic signals, so as to avoid generating clutters, and improve the accuracy of touch detection or fingerprint recognition. In addition, the common electrode 113 is grounded when the piezoelectric layer 112 receives the first reflected ultrasonic signal or the second reflected ultrasonic signal, thereby preventing the voltage at the common electrode 113 from having adverse effects on the first electrical signal or the second electrical signal acting on the electrode array 111, and ensuring the effects of touch detection or fingerprint recognition.

In some optional embodiments, the electrode array 111 comprises a plurality of electrodes. The circuit unit comprises a plurality of preprocessing circuits and an output unit. Each of the plurality of preprocessing circuits is connected to the output unit; and different preprocessing circuits are connected to different electrodes.

The preprocessing circuit is configured to preprocess the first electrical signal to generate a first preprocessed signal, or preprocess the second electrical signal to generate a second preprocessed signal. As an example, the preprocessing on the first electrical signal or the second electrical signal via the preprocessing circuits may include operations such as detecting a signal amplitude and denoising, to reduce the processing work of the output unit.

The output unit is configured to generate the touch detection signal based on the first preprocessed signal and output the touch detection signal, or generate the fingerprint recognition signal based on the second preprocessed signal and output the fingerprint recognition signal.

It should be understood that in an implementation of the present disclosure, the preprocessing circuit and the output unit are configured to perform preprocessing and postprocessing on the first electrical signal or the second electrical signal in cooperation with labor division. The present disclosure does not impose any limitation on the labor division between the preprocessing circuit and the output unit.

When the piezoelectric layer 112 receives the first reflected ultrasonic signal, some of the preprocessing circuits connected to some of the electrodes 1111 included in the electrode array 111 are in a working state, and other preprocessing circuits connected to other electrodes 1111 included in the electrode array 111 are in a sleep state. The preprocessing circuits in a sleep state will no longer perform corresponding preprocessing work, thereby reducing corresponding power consumption.

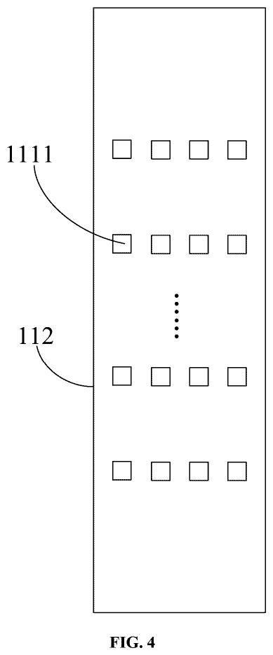

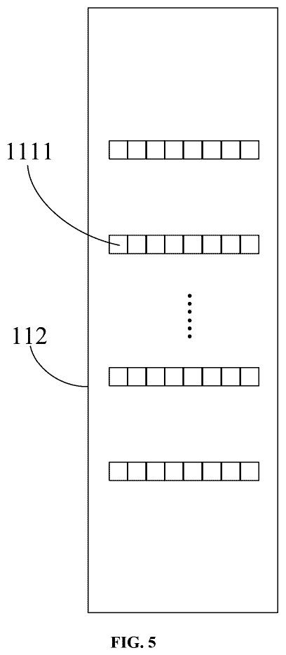

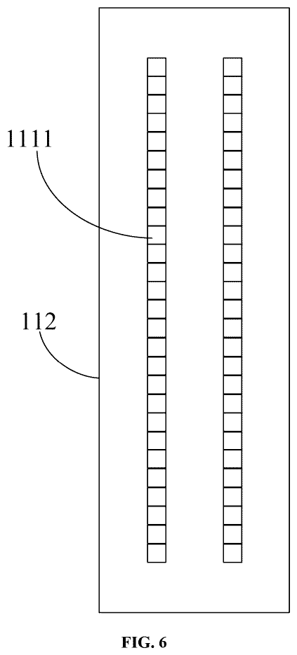

As an example, FIGS. 4-6 show some electrodes 1111 of the electrode array 111 in the figures. When the piezoelectric layer 112 receives the first reflected ultrasonic signal, only some of the preprocessing circuits connected to some electrodes 1111 shown in FIG. 4, 5, or 6 may be in a working state, and the remaining preprocessing circuits connected to the remaining electrodes 1111 are in a sleep state. In this case, power consumption of the preprocessing can be reduced by enabling some of the preprocessing circuits to be in a sleep state, and the output unit only needs to process first preprocessed electrical signals generated by some of the preprocessing circuits, thereby reducing the power consumption of the output unit.

In some optional embodiments, when the piezoelectric layer 112 receives the second reflected ultrasonic signal, all of the preprocessing circuits connected to all of the electrodes included in the electrode array 111 are in a working state.

As described above, after the second reflected ultrasonic signal is converted into the second electrical signal, the circuit unit 120 can generate the fingerprint recognition signal indicating the fingerprint feature based on the second electrical signal. Therefore, when the piezoelectric layer 112 receives the second reflected ultrasonic signal, all of the preprocessing circuits connected to all of the electrodes included in the electrode array 111 are in a working state, so that the output unit can receive second preprocessed signals generated based on second electrical signals at all of the electrodes in the electrode array 111, thereby generating many fingerprint detection signals based on many second electrical signals, extracting enough fingerprint features from the generated fingerprint detection signals, and improving the accuracy of fingerprint recognition.

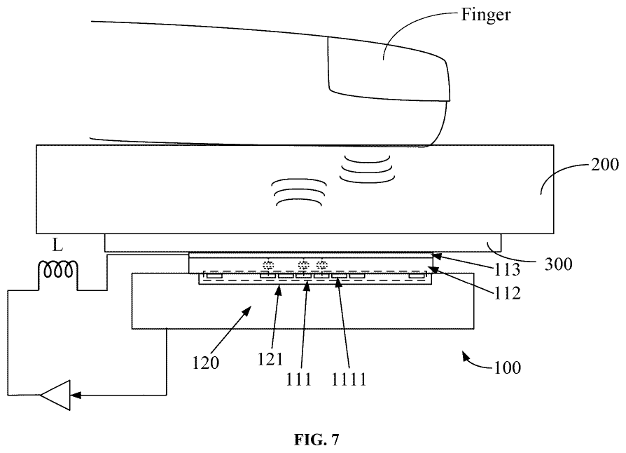

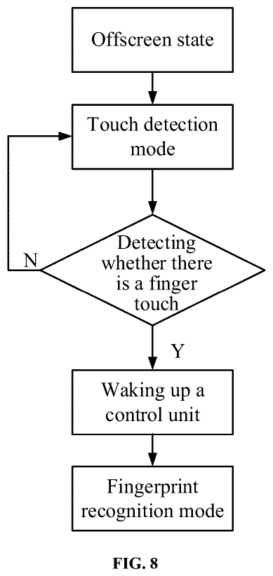

As shown in FIG. 1 or 7, in some optional embodiments, the circuit unit 120 contacts the electrode array 111. As an example, the electrode array 111 may be directly arranged on the silicon substrate 121 of the circuit unit 120. In addition, the common electrode 113 may contact the cover plate 200 through an adhesive layer 300, or the circuit unit 120 may contact the cover plate 200 through an adhesive layer 300.

In an embodiment of the present disclosure, after the circuit unit 120 is arranged to contact the electrode array 111, not only can the common electrode 113 contact the cover plate 200 through the adhesive layer 300, but also the circuit unit 120 can contact the cover plate 200 through the adhesive layer 300, of which the structural arrangement is flexible, and can facilitate the combination of the apparatus 100 for ultrasonic detection and the electronic device.

As shown in FIG. 2, in some optional embodiments, if the piezoelectric layer 112 starts to emit the first ultrasonic signal to the cover plate 200 at a first moment t₁, the piezoelectric layer 112 is configured to receive the first reflected ultrasonic signal after a first time X₁ from the first moment (i.e., moment t₂ in the figure).

As a feasible implementation, a value range of the first time X₁ can be set based on a horizontal coordinate range with a large amplitude difference between the dotted waveform and the solid waveform on the R axis in FIG. 2, so that the first reflected ultrasonic signal received by the piezoelectric layer 112 can have a relatively obvious difference in a case where there is a finger touch and in a case where there is no finger touch.

In some optional embodiments, the value range of the first time is (1.8 T, 3 T), that is, value of the first time may be within a range of greater than 1.8 T and less than 3 T, for example, the first time may be set to, e.g., 1.9 T, 2.2 T, 2.5 T, or 2.8 T. T is a time interval from starting to emit the ultrasonic signal via the piezoelectric layer 112 to starting to receive a target reflected signal via the piezoelectric layer 112, and the target reflected signal is a signal formed by reflection of the ultrasonic signal from a touch surface of the cover plate 200.

Referring to FIG. 1 or 7, if the piezoelectric layer 112 emits the ultrasonic signal to the cover plate 200, when the ultrasonic signal is transmitted to an interface between the adhesive layer 300 and the cover plate 200, the ultrasonic signal will be partially reflected from the interface, forming a reflected signal that reaches the piezoelectric layer 112 earlier. When the ultrasonic signal continues to be transmitted from the interface between the adhesive layer 300 and the cover plate 200 to the touch surface of the cover plate 200, the ultrasonic signal will be further reflected from the touch surface of the cover plate 200, forming a reflected signal that reaches the piezoelectric layer 112 later, i.e., the above target reflected signal.

In an embodiment of the present disclosure, the value range of the first time is (1.8 T, 3 T), which can enable the apparatus for ultrasonic detection to generate a touch detection signal based on the first reflected ultrasonic signal formed by reflection of the first ultrasonic signal from the touch surface on the cover plate 200, thereby ensuring that the touch detection signal can better indicate the touch state of the cover plate 200, thereby improving the accuracy of touch detection.

In some optional embodiments, the piezoelectric layer 112 is configured to receive, in response to starting to emit the second ultrasonic signal to the cover plate 200 via the piezoelectric layer 112 at a second moment, the second reflected ultrasonic signal after a second time from the second moment; wherein a value range of the second time is different from the value range of the first time.

In an embodiment of the present disclosure, fingerprint imaging can be performed based on the fingerprint recognition signal to facilitate fingerprint recognition. The value range of the second time can be determined based on imaging effects of the fingerprint recognition signal corresponding to the second reflected ultrasonic signal, that is, the first time can be calibrated based on the imaging effects of the fingerprint recognition signal.

As a feasible implementation, a plurality of second times may be set in a continuous process of emitting a plurality of second ultrasonic signals and generating corresponding fingerprint recognition signals, to obtain fingerprint images corresponding to the second times. By superimposing the fingerprint images corresponding to the second times, a relatively complete fingerprint image can be obtained to improve the accuracy of fingerprint recognition.

There should not be too large differences among the plurality of second times, to avoid missing some fingerprint features. A difference between two second times with adjacent magnitudes among the plurality of second times may be set to be less than or equal to ¼ of a cycle of the second ultrasonic signal, for example, the difference between two second times with adjacent magnitudes may be set to be, e.g., ⅕ of the cycle of the second ultrasonic signal or ⅙ of the cycle of the second ultrasonic signal.

In an embodiment of the present disclosure, one of the second times with a different value range from the value range of the first time is used, so that the second time is free from the limitation of the value range of the first time, so as to set the time for receiving the second reflected ultrasonic signal for fingerprint recognition, thereby ensuring the accuracy of fingerprint recognition.

In some optional embodiments, the value range of the second time is (1.5 T, 2 T), that is, value of the second time may be within a range of greater than 1.5 T and less than 2 T, for example, the second time may be set to, e.g., 1.6 T, 1.7 T, 1.8 T, or 1.9 T.

In an embodiment of the present disclosure, the value range of the second time is (1.5 T, 2 T), which can enable the apparatus for ultrasonic detection to generate a fingerprint recognition signal based on the second reflected ultrasonic signal formed by reflection of the second ultrasonic signal from the touch surface on the cover plate 200, thereby ensuring that the fingerprint recognition signal can clearly indicate fingerprint features of the finger when the cover plate 200 is touched, to improve the accuracy of fingerprint recognition.

The process of using the apparatus for ultrasonic detection for touch detection and fingerprint recognition is introduced below with reference to a feasible embodiment.

In an embodiment of the present disclosure, a touch screen of the electronic device may serve as the cover plate, and the apparatus for ultrasonic detection is located below the touch screen.

As shown in FIG. 8, when the touch screen is in an offscreen state, the apparatus for ultrasonic detection is in a touch detection mode, and is configured to detect whether there is a finger touch on the display screen. If a finger touch is detected, the apparatus for ultrasonic detection can send a signal indicating the presence of a finger touch to a control unit, and wake up the control unit controlling its working mode in the apparatus for ultrasonic detection, so that the control unit controls the apparatus for ultrasonic detection to enter a fingerprint recognition mode from the touch detection mode based on the touch notification. If no finger touch is detected, the apparatus for ultrasonic detection will continue to be in the touch detection mode.

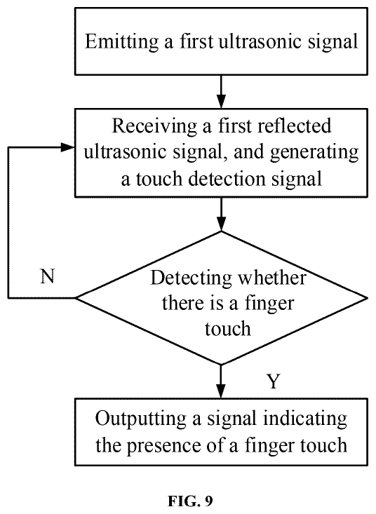

As shown in FIG. 9, in the touch detection mode, the apparatus for ultrasonic detection can continuously emit first ultrasonic signals to the touch screen through the piezoelectric transducer, and receive first reflected ultrasonic signals, thereby generating touch detection signals that can indicate the touch state of the touch screen. The apparatus for ultrasonic detection may be provided with a corresponding detection module to determine, via the detection module, the touch state of the touch screen indicated by the touch detection signals, thereby detecting whether there is a finger touch. The above embodiments may be referred to for the principle of the touch state of the touch screen indicated by the touch detection signals, which will not be repeated here. If a finger touch is detected, the detection module can output a signal indicating the presence of a finger touch; while if no finger touch is detected, the piezoelectric transducer can repeat the process of receiving the first reflected ultrasonic signals to continue to detect whether there is a finger touch.

In the fingerprint recognition mode, the apparatus for ultrasonic detection can enable the piezoelectric transducer to emit a second ultrasonic signal to the touch screen, and receive a second reflected ultrasonic signal to generate a fingerprint recognition signal. After the fingerprint recognition signal is generated, a CPU in the electronic device can be invoked to perform fingerprint recognition based on the fingerprint recognition signal. The related art may be referred to for a specific process of fingerprint recognition based on the fingerprint recognition signal, which will not be repeated here.

In an embodiment of the present disclosure, before fingerprint recognition is performed, the apparatus for ultrasonic detection may be in the touch detection mode to detect whether there is a finger touch on the touch screen, and determine whether to enable the fingerprint recognition mode based on the touch detection result. In the touch detection mode, some preprocessing circuits in the piezoelectric transducer may be in a sleep state, thereby achieving the effect of reducing power consumption, and avoiding waste of electrical energy caused by only enabling the fingerprint recognition mode.

An embodiment of the present disclosure further provides an electronic device, comprising a cover plate 200 and the apparatus 100 for ultrasonic detection in any one of the above embodiments. The cover plate 200 is configured to provide a touch surface configured to receive a finger touch. The apparatus 100 for ultrasonic detection is arranged below the cover plate 200 to perform touch detection on the cover plate 200.

The electronic device provided in the embodiment of the present disclosure and the above embodiments of the apparatus 100 for ultrasonic detection are based on the same inventive concept and can achieve the same effects. The description in the above embodiments of the apparatus 100 for ultrasonic detection may be referred to for a specific implementation of the electronic device, which will not be repeated here.

In some optional embodiments, the cover plate 200 of the electronic device may be formed from a conductive material, or may be formed from a non-conductive material.

In the related art, when a finger touch is detected using an apparatus for capacitive touch detection, the touch surface of the finger is usually required to be a non-conductor. Therefore, when it is used to detect a touch on the cover plate of the electronic device, the cover plate of the electronic device usually can only be a cover plate made of a non-conductive material. In an embodiment of the present disclosure, the cover plate 200 of the electronic device may be formed from a conductive material, or may be made from a non-conductive material, thereby reducing the restrictions on the material of the cover plate 200, and providing a higher degree of freedom for the cover plate design of the electronic device.

It should be noted that, depending on the implementation requirements, the components/steps described in the embodiments of the present disclosure may be split into more components/steps, or two or more components/steps or partial operations of the components/steps may be combined into novel components/steps to achieve the goal of the embodiments of the present disclosure.

As will be appreciated by those of ordinary skills in the art, the various example units and method steps described in combination with the embodiments disclosed herein can be implemented by electronic hardware, or a combination of computer software and electronic hardware. Whether these functions are executed by hardware or software depends on applications and design constraints of the technical solutions. Those skilled in the art may implement the described functions for each particular application using different methods, but such implementation should not be considered as falling beyond the scope of the embodiments of the present disclosure.

The above embodiments are only used to illustrate the embodiments of the present disclosure, and are not intended to limit the embodiments of the present disclosure. Those of ordinary skills in the relevant technical field may further make various alterations and modifications without departing from the spirit and scope of the embodiments of the present disclosure. Therefore, all equivalent technical solutions are also encompassed within the scope of the embodiments of the present disclosure, and the scope of patent protection of the embodiments of the present disclosure should be defined by the claims.

1. An apparatus for ultrasonic detection, arranged below a cover plate of an electronic device to perform touch detection on the cover plate and comprising: a piezoelectric transducer and a circuit unit; wherein
the piezoelectric transducer is configured to emit a first ultrasonic signal to the cover plate, receive a first reflected ultrasonic signal formed by reflection of the first ultrasonic signal, convert the first reflected ultrasonic signal into a first electrical signal, and input the first electrical signal into the circuit unit; and
the circuit unit is configured to generate a touch detection signal indicating a touch state of the cover plate based on the first electrical signal.

2. The apparatus according to claim 1, wherein
the piezoelectric transducer is configured to emit a second ultrasonic signal to the cover plate, receive a second reflected ultrasonic signal formed by reflection of the second ultrasonic signal, convert the second reflected ultrasonic signal into a second electrical signal, and input the second electrical signal into the circuit unit; and
the circuit unit is configured to generate a fingerprint recognition signal indicating a fingerprint feature based on the second electrical signal.

3. The apparatus according to claim 2, wherein the piezoelectric transducer comprises an electrode array, a piezoelectric layer, and a common electrode, wherein the common electrode and the electrode array are located on opposite sides of the piezoelectric layer respectively;
the common electrode is configured to drive the piezoelectric layer to emit the first ultrasonic signal or the second ultrasonic signal; and
the piezoelectric layer is configured to convert the first reflected ultrasonic signal into the first electrical signal acting on the electrode array after receiving the first reflected ultrasonic signal, and convert the second reflected ultrasonic signal into the second electrical signal acting on the electrode array after receiving the second reflected ultrasonic signal;
wherein, when the piezoelectric layer emits the first ultrasonic signal or the second ultrasonic signal, the electrode array is grounded, and when the piezoelectric layer receives the first reflected ultrasonic signal or the second reflected ultrasonic signal, the common electrode is grounded.

4. The apparatus according to claim 3, wherein the electrode array comprises a plurality of electrodes;
the circuit unit comprises a plurality of preprocessing circuits and an output unit;
each of the plurality of preprocessing circuits is connected to the output unit; and different preprocessing circuits are connected to different electrodes;
each of the preprocessing circuits is configured to preprocess the first electrical signal to generate a first preprocessed signal, or preprocess the second electrical signal to generate a second preprocessed signal; the output unit is configured to generate the touch detection signal based on the first preprocessed signal and output the touch detection signal, or generate the fingerprint recognition signal based on the second preprocessed signal and output the fingerprint recognition signal;
when the piezoelectric layer receives the first reflected ultrasonic signal, some of the preprocessing circuits connected to some of the electrodes included in the electrode array are in a working state, other preprocessing circuits connected to other electrodes in the electrode array are in a sleep state; and
when the piezoelectric layer receives the second reflected ultrasonic signal, all of the preprocessing circuits connected to all of the electrodes in the electrode array are in a working state.

5. The apparatus according to claim 3, wherein the circuit unit is configured to contact the electrode array; and
the common electrode is configured to contact the cover plate through an adhesive layer, or the circuit unit is configured to contact the cover plate through an adhesive layer.

6. The apparatus according to claim 3, wherein
the piezoelectric layer is configured to receive, in response to starting to emit the first ultrasonic signal to the cover plate via the piezoelectric layer at a first moment, the first reflected ultrasonic signal after a first time from the first moment, a value range of the first time being (1.8 T, 3 T); and
T is a time interval from starting to emit an ultrasonic signal via the piezoelectric layer to starting to receive a target reflected signal via the piezoelectric layer, wherein the target reflected signal is a signal formed by reflection of the ultrasonic signal from a touch surface of the cover plate.

7. The apparatus according to claim 6, wherein
the piezoelectric layer is configured to receive, in response to starting to emit the second ultrasonic signal to the cover plate via the piezoelectric layer at a second moment, the second reflected ultrasonic signal after a second time from the second moment;
wherein a value range of the second time is different from the value range of the first time.

8. The apparatus according to claim 7, wherein
the value range of the second time is (1.5 T, 2 T).

9. An electronic device, comprising: a cover plate and an apparatus for ultrasonic detection arranged below a cover plate of the electronic device to perform touch detection on the cover plate, the apparatus for ultrasonic detection comprising: a piezoelectric transducer and a circuit unit; wherein
the piezoelectric transducer is configured to emit a first ultrasonic signal to the cover plate, receive a first reflected ultrasonic signal formed by reflection of the first ultrasonic signal, convert the first reflected ultrasonic signal into a first electrical signal, and input the first electrical signal into the circuit unit; and
the circuit unit is configured to generate a touch detection signal indicating a touch state of the cover plate based on the first electrical signal,
the cover plate is configured to provide a touch surface configured to receive a finger touch; and
the apparatus for ultrasonic detection is arranged below the cover plate to perform touch detection on the cover plate.

10. The electronic device according to claim 9, wherein the cover plate is formed from a conductive material or a non-conductive material.

11. The electronic device according to claim 9, wherein
the piezoelectric transducer is configured to emit a second ultrasonic signal to the cover plate, receive a second reflected ultrasonic signal formed by reflection of the second ultrasonic signal, convert the second reflected ultrasonic signal into a second electrical signal, and input the second electrical signal into the circuit unit; and
the circuit unit is configured to generate a fingerprint recognition signal indicating a fingerprint feature based on the second electrical signal.

12. The electronic device according to claim 9, wherein the piezoelectric transducer comprises an electrode array, a piezoelectric layer, and a common electrode, wherein the common electrode and the electrode array are located on opposite sides of the piezoelectric layer respectively;
the common electrode is configured to drive the piezoelectric layer to emit the first ultrasonic signal or the second ultrasonic signal; and
the piezoelectric layer is configured to convert the first reflected ultrasonic signal into the first electrical signal acting on the electrode array after receiving the first reflected ultrasonic signal, and convert the second reflected ultrasonic signal into the second electrical signal acting on the electrode array after receiving the second reflected ultrasonic signal;
wherein, when the piezoelectric layer emits the first ultrasonic signal or the second ultrasonic signal, the electrode array is grounded, and when the piezoelectric layer receives the first reflected ultrasonic signal or the second reflected ultrasonic signal, the common electrode is grounded.

13. The electronic device according to claim 12, wherein the electrode array comprises a plurality of electrodes;
the circuit unit comprises a plurality of preprocessing circuits and an output unit;
each of the plurality of preprocessing circuits is connected to the output unit; and different preprocessing circuits are connected to different electrodes;
each of the preprocessing circuits is configured to preprocess the first electrical signal to generate a first preprocessed signal, or preprocess the second electrical signal to generate a second preprocessed signal; the output unit is configured to generate the touch detection signal based on the first preprocessed signal and output the touch detection signal, or generate the fingerprint recognition signal based on the second preprocessed signal and output the fingerprint recognition signal;
when the piezoelectric layer receives the first reflected ultrasonic signal, some of the preprocessing circuits connected to some of the electrodes included in the electrode array are in a working state, other preprocessing circuits connected to other electrodes in the electrode array are in a sleep state; and
when the piezoelectric layer receives the second reflected ultrasonic signal, all of the preprocessing circuits connected to all of the electrodes in the electrode array are in a working state.

14. The electronic device according to claim 12, wherein the circuit unit is configured to contact the electrode array; and
the common electrode is configured to contact the cover plate through an adhesive layer, or the circuit unit is configured to contact the cover plate through an adhesive layer.

15. The electronic device according to claim 12, wherein
the piezoelectric layer is configured to receive, in response to starting to emit the first ultrasonic signal to the cover plate via the piezoelectric layer at a first moment, the first reflected ultrasonic signal after a first time from the first moment, a value range of the first time being (1.8 T, 3 T); and
T is a time interval from starting to emit an ultrasonic signal via the piezoelectric layer to starting to receive a target reflected signal via the piezoelectric layer, wherein the target reflected signal is a signal formed by reflection of the ultrasonic signal from a touch surface of the cover plate.

16. The electronic device according to claim 15, wherein
the piezoelectric layer is configured to receive, in response to starting to emit the second ultrasonic signal to the cover plate via the piezoelectric layer at a second moment, the second reflected ultrasonic signal after a second time from the second moment;
wherein a value range of the second time is different from the value range of the first time.

17. The electronic device according to claim 16, wherein
the value range of the second time is (1.5 T, 2 T).
